(19) United States
(12) Patent Application Publication
(10) Pub. No.: US 2016/0112463 A1
(43) Pub. Date: Apr. 21, 2016

(54) SYSTEMS AND METHODS FOR ESTABLISHING A TELEPHONE CONNECTION

(71) Applicant: KANFIELD CAPITAL SA, Panama (PA)

(72) Inventor: Silviu Caragea, Bucharest (RO)

(73) Assignee: KANFIELD CAPITAL SA, Panama (PA)

(21) Appl. No.: 14/516,092

(22) Filed: Oct. 16, 2014

(51) Int. Cl. H04L 29/06; H04M 7/00; H04W 76/02; H04L 29/08

(52) U.S. Cl. CPC H04L 65/1069; H04L 67/26; H04M 7/006; H04W 76/021

(57) ABSTRACT

Systems for and methods of delivering telephone calls from a VoIP platform to an Internet enabled telecommunication device are disclosed. The VoIP platform may cause a push notification to be sent to the second telecommunication device in order to initiate an active Internet session for connection of a VoIP call to a virtual number associated with the second telecommunication device.

### FIELD OF THE INVENTION

The present invention relates to systems and methods for connecting telephone calls between two handsets, at least in part using an Internet connection, such as one provided by a Voice over Internet Protocol (VoIP) enabled switch.

### BACKGROUND OF THE INVENTION

Telecommunication devices, such as mobile phones, landline phones, and satellite phones, are commonly used to facilitate communication between one or more persons. Communication using these telecommunication devices may be in the form of voice communication, text messages, instant messaging, sound (e.g., audible alerts), video, picture, or multi-media information. Voice communication may be with one person or with more than one person in the form of a three-way call or a conference call.

For voice communication, the caller may dial a number from his telecommunication device and the call may be routed through one or more telecommunication networks to the recipient's telecommunication device. In some instances, the call may be routed through the networks of one or more long distance and/or international carriers. The long distance and international carriers may each impose tariffs for completing the call based on a variety of criteria. Once the call is completed, the caller's phone service provider may bill the caller for servicing the call.

For landline service, rates for outbound calling have dropped sharply due to competition between long distance carriers and VoIP services. VoIP audio interface software may enable phone-like connections over the Internet. Some examples of these types of services are MSN Messenger, Yahoo Messenger, AIM/ICQ, and Skype. This software operates by compressing audio and sending it over a TCP or UDP IP connection as digital information. The major advantage of this type of technology is that it permits users to make telephone calls that bypass telephone companies and their charges. However, a disadvantage of this type of calling is that both caller and callee telecommunication devices have to be engaged in an active Internet session (i.e., logged on) simultaneously.

One way to alleviate the problem of comparatively higher costs for long distance and international calls to mobile phones is to use the Internet for voice calls to an Internet enabled telephone, such as a smart phone. If the called telephone has an active Internet session in progress, the recipient of the call may choose to receive the call and communicate with the caller like any other VoIP user. However, it is often the case that the called Internet enabled phone does not have an active Internet session at the time of an incoming VoIP call. For example, an Internet enabled telecommunication device may not maintain an active Internet session at all times due to network cost, network capacity, and power consumption considerations. Accordingly, the VoIP solution has not provided viable competition to cellular service.

Thus, there is a need for methods and apparatus for facilitating VoIP calls for Internet enabled telecommunication devices regardless of the devices' maintenance of an active Internet session at all times. It is therefore an advantage of some, but not necessarily all, embodiments of the present invention to provide systems and methods for facilitating VoIP calls to Internet enabled telecommunication services which do not have an active Internet session in progress at the time of an incoming VoIP call.

Additional advantages of various embodiments of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicant has developed an innovative method of connecting a telephone call between first and second telecommunication devices using a VoIP platform, comprising: associating a virtual telephone number with a second telecommunication device in a VoIP platform memory; associating the second telecommunication device with a push notification service in the VoIP platform memory; receiving, at the VoIP platform, a data signal initiated by a first telecommunication device, said data signal identifying the virtual telephone number to which a telephone call is directed; automatically identifying the second telecommunication device associated with the virtual telephone number using the VoIP platform responsive to receipt of the data signal identifying the virtual telephone number; automatically determining if the second telecommunication device has an active Internet session in progress, responsive to identification of the second telecommunication device, using the VoIP platform; automatically transmitting a push notification data signal for the second telecommunication device from the VoIP platform to a server associated with the push notification service if the second telecommunication device does not have an active Internet session in progress; receiving a request at the VoIP platform from the second telecommunication device to establish an active Internet session between the second telecommunication device and the VoIP platform; receiving a data signal providing a redirection request from the second telecommunication device at the VoIP platform using an established active Internet session; automatically transmitting a data signal providing SDP information from the VoIP platform to the second telecommunication device responsive to receipt of the redirection request; receiving a data signal providing an auto-answer from the second telecommunication device at the VoIP platform, said data signal providing an auto-answer being transmitted responsive to receipt of the data signal providing SDP information at the second telecommunication device; automatically connecting the second telecommunication device with the first telecommunication device at the VoIP platform for a voice session of the telephone call; and transmitting a voice data signal to the second telecommunication device from the VoIP platform using the active Internet session responsive to receipt of a voice signal at the VoIP platform from the first telecommunication device.

Applicant has further developed an innovative computer-implemented system for automatically connecting a telephone call between first and second telecommunication devices, comprising: means for receiving a data signal initiated by a first telecommunication device, said data signal identifying a virtual telephone number to which a telephone call is directed; means for automatically identifying a second telecommunication device associated with the virtual telephone number; means for automatically determining if the second telecommunication device has an active Internet session in progress; means for identifying a push notification service with which the second telecommunication device is registered; means for automatically transmitting a push notification data signal to a server associated with the push notification service; means for maintaining an active Internet session with the second telecommunication device; means for automatically transmitting a data signal providing SDP information to the second telecommunication device; and means for transmitting a voice data signal to the second telecommunication device responsive to receipt of a voice signal from the first telecommunication device.

Applicant has further developed an innovative computer-readable medium including contents that are configured to cause a computing system to connect a telephone call between first and second telecommunication devices using a VoIP platform by performing a method comprising: associating a virtual telephone number with a second telecommunication device in a VoIP platform memory; associating the second telecommunication device with a push notification service in the VoIP platform memory; receiving, at the VoIP platform, a data signal initiated by a first telecommunication device, said data signal identifying the virtual telephone number to which a telephone call is directed; automatically identifying the second telecommunication device associated with the virtual telephone number using the VoIP platform responsive to receipt of the data signal identifying the virtual telephone number; automatically determining if the second telecommunication device has an active Internet session in progress, responsive to identification of the second telecommunication device, using the VoIP platform; automatically transmitting a push notification data signal for the second telecommunication device from the VoIP platform to a server associated with the push notification service if the second telecommunication device does not have an active Internet session in progress; receiving a request at the VoIP platform from the second telecommunication device to establish an active Internet session between the second telecommunication device and the VoIP platform; receiving a data signal providing a redirection request from the second telecommunication device at the VoIP platform using an established active Internet session; automatically transmitting a data signal providing SDP information from the VoIP platform to the second telecommunication device responsive to receipt of the redirection request; receiving a data signal providing an auto-answer from the second telecommunication device at the VoIP platform, said data signal providing an auto-answer being transmitted responsive to receipt of the data signal providing SDP information at the second telecommunication device; automatically connecting the second telecommunication device with the first telecommunication device at the VoIP platform for a voice session of the telephone call; and transmitting a voice data signal to the second telecommunication device from the VoIP platform using the active Internet session responsive to receipt of a voice signal at the VoIP platform from the first telecommunication device.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic diagram illustrating a network architecture that may be used to provide telephone service in accordance with embodiments of the present invention.

FIG. 2 is a workflow call sequence diagram illustrating a method of connecting telephone calls in accordance with embodiments of the present invention.

### GLOSSARY OF ABBREVIATIONS

In order to assist the understanding of this invention, the following glossary of abbreviations is provided.

DID—Direct Inward Dialing

IP—Internet Protocol

PNS—Push Notification Service platform

PSTN—Public Switched Telephone Network

SDP—Session Description Protocol

SIP—Session Initiation Protocol

TCP—Transmission Control Protocol

UDP—User Datagram Protocol

### DETAILED DESCRIPTION OF EMBODIMENTS OF THE INVENTION

Reference will now be made in detail to embodiments of the present invention, examples of which are illustrated in the accompanying drawings. It is to be understood that other embodiments may be utilized and structural changes may be made without departing from the scope of the present invention.

An embodiment of the invention utilizes a network and network devices to facilitate communication between telecommunication devices in a manner that circumvents the use of intermediary carriers typically required to complete a long distance or international call. Embodiments of the present invention include both apparatus and methods for permitting and enabling telecommunication devices to communicate over long distances and may reduce the cost previously associated with such communications by circumventing long distance and international telecommunications carriers.

The various apparatus and methods discussed herein may be implemented between two or more telecommunication devices that are connected through a telecommunication network, over the Internet, or via a combination thereof. One skilled in the art will recognize that the present invention can be implemented using any type of telecommunication device, including, for example, conventional telephones, wireless telephones, cellular telephones, personal digital assistants (PDAs), personal communication devices, smart phones, tablet computers, handheld email devices, handheld computers, desktop computers, laptop computers, or any communication device capable of transmitting and receiving information via a video or telecommunication related service so long as at least one such telecommunication is Internet enabled. By Internet enabled, it is meant that the telecommunication device includes the necessary hardware and software, including a browser, to establish and maintain an active TCP/IP or UDP/IP Internet session with another Internet device, such as a server or VoIP switch.

An exemplary embodiment of the telecommunication devices that are used in embodiments of the invention may be capable of voice services and/or data services over networks such as GSM/GPRS/EDGE, UMTS, CDMA, WiFi, WiMAX, 3G, 4G, LTE, EVDO, mesh, or other networks types. Accordingly, any particular structure and design of the telecommunication devices is merely one example of a physical device for implementing the techniques of the present invention, and is presented for illustrative purposes and not to imply any limitations on the scope of the present invention. To the extent that the present invention is composed of electronic components and circuits, which are generally known to those skilled in the art, circuit details are not specified in order not to detract from the teachings of the present invention.

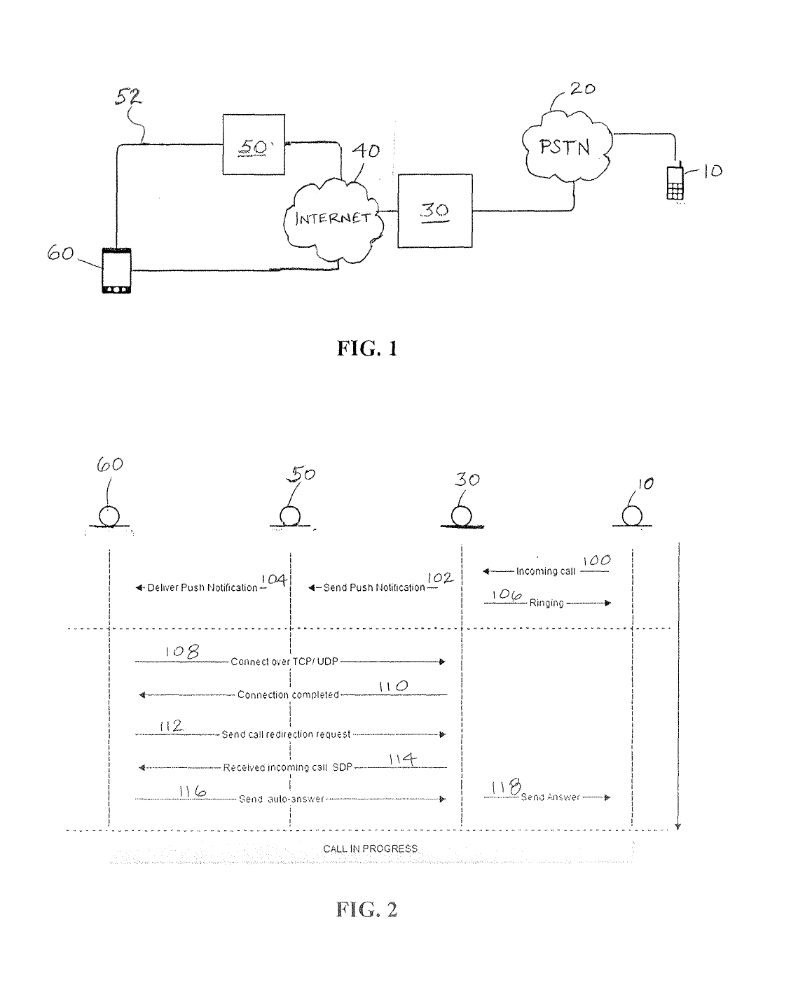

Reference will now be made in detail to one or more embodiments of the present invention, examples of which are depicted in the accompanying FIGS. 1-2. With reference to FIG. 1, a first telecommunication device 10 may be connected via the PSTN 20 to a VoIP platform 30. In turn, the VoIP platform 30 may selectively connect to a Push Notification Service platform (PNS) 50 to a second telecommunication device 60 which is Internet enabled via the Internet 40. The PNS 50 may selectively connect to the second telecommunication device 60 via a push notification service channel 52 which may or may not be carried over the Internet in whole or part.

The VoIP platform 30 may include one or more VoIP switches, gateways and associated servers, processors and non-transitory computer memory required to carry out the embodiments of the invention. The VoIP platform 30 may be capable of transmitting and receiving voice signals to and from the PSTN 20, as well as transmitting and receiving data signals carrying voice information over TCP/IP and/or UDP/IP Internet connections.

The PNS 50 may include one or more servers which are capable of transmitting push notification data signals over the push notification service channel 52 to one or more associated telecommunication devices such as the second telecommunication device 60. Push notifications may be Internet-based communications where the request for a given transaction is initiated by the publisher or central server as compared with a client. More specifically, a push notification may be an Internet-based communication data signal used by smart phone operating system manufacturers to deliver notifications to their devices coming from a central server. In embodiments of the present invention, the second telecommunication device 60 stands in the role of a client and the PNS 50 stands in the role of a publisher or central server in connection with push notifications. The operator of the PNS 50 may be the manufacturer or seller of the second telecommunication device 60. Among other capabilities, for purposes of embodiments of the present invention, a push notification data signal received at the second telecommunication device 60 may be used to activate (i.e., open) a client application on the device under the control of the device operating system.

The second telecommunication device 60 may include one or more mechanisms for accepting input from a user. In one embodiment, the screen is touch-sensitive, so that the user may interact with the second telecommunication device 60 by touching or writing on the surface of screen using a stylus, finger, or other object. In another embodiment, in addition to, or as a surrogate for, the touch-sensitive screen, the second telecommunication device 60 may include a QWERTY keyboard, or any other type of keyboard or button or swipe based interface, for enabling rapid entry of an input, including text, and may further include buttons for performing various other functions associated with the operation of the second telecommunication device and its applications. The second telecommunication device 60 may also have a memory that stores, and a processor that executes, a client application, described below.

In one embodiment of the present invention, a client application—which may include but is not limited to a computer program, software, script, executable file, client, or application—may be stored in memory associated with, and capable of being run on, the second telecommunication device 60. The client application may be adapted to run on a range of application platforms, including, for example, J2ME, Windows Mobile, Windows 8, Windows RT, Blackberry OS, iOS, Android, Symbian, Palm OS, or the like. The client application may also be adapted to run on Windows, Chrome, Unix, Linux, Mac OS, and other similar operating systems supported on handheld/desktop computers and the like. In one embodiment, the client application may be pre-installed on the second telecommunication device or available for download from a variety of repositories, including, for example, Google Play, Apples' iTunes or App Store, Windows' Store, Amazon's Appstore, or the like. The client application may further be available for download at a FTP or Internet site or from a local or network drive.

In one embodiment, a user may register the second telecommunication device 60 with the VoIP platform 30. Registration may require activation of a virtual telephone number (e.g. DID or access number) for association with the second telecommunication device 60 at the VoIP platform 30 in associated non-transitory memory. The VoIP platform 30 may automatically associate one or more virtual telephone numbers uniquely with the second telecommunication device 60. Registration may also involve downloading and storing the client application associated with the VoIP platform 30 on the second telecommunication device 60. The client application may be configured to automatically open on the second telecommunication device 60 under the direction of its operating system upon receipt of a push notification data signal from the PNS 50 which is initiated by the VoIP platform 30. Registration may further involve associating the second telecommunication device 60 with a particular PNS 50 in non-transitory memory at the VoIP platform 30.

With reference to FIG. 2, a telephone call from the first telecommunication device 10 to a virtual telephone number associated with the second telecommunication device 60 may be connected in accordance with the following method. In step 100, the first telecommunication device 10 may be used to dial the virtual number, causing a data signal identifying the virtual telephone number to be transmitted over the PSTN 20 to the VoIP platform 30. Responsive to receipt of the data signal, the VoIP platform 30 may automatically search memory for the virtual telephone number to identify the second telecommunication device associated with it. The VoIP platform 30 may also automatically transmitted a data signal back to the first telecommunication device 10 which causes a ringing state for the first telecommunication device. Once the second telecommunication device 60 is identified, the VoIP platform 30 may automatically determine if the second telecommunication device has an active Internet session in progress that can be used to service the call. The VoIP platform 30 may make this determination by attempting to establish a TCP/IP or UDP/IP connection with the second telecommunication device 60 over the Internet 40. If an Internet connection is established between the VoIP platform 30 and the second telecommunication device 60, the VoIP platform will automatically connect the call from the first telecommunication device 10 to the second telecommunication device 60 in accordance with conventional VoIP processes.

If, however, the second telecommunication device 60 is determined not have an active Internet session in progress that can be used for the incoming call, the VoIP platform 30 may automatically search memory to identify a PNS 50 with which the second telecommunication device 60 is associated. Once the correct PNS 50 is identified, the VoIP platform 30 may automatically transmit a data signal to the PNS 50, preferably over the Internet 40, which provides instruction for a push notification to be sent from the PNS 50 to the second telecommunication device 60 in step 102. The data signal sent from the VoIP platform 30 to the PNS 50 may include a unique call identifier and caller information associated with the first telecommunication device, such as caller telephone number and name, as well as any identifying information for the second telecommunication device 60 which is need for the PNS 50 to send a push notification to the second telecommunication device. In step 104, the PNS 50 may transmit a push notification data signal over the push notification service channel 52 to the second telecommunication device 60. The push notification sent from the PNS 50 may include the unique call identifier and caller identification information referenced above.

In step 108, the receipt of the push notification data signal at the second telecommunication device 60 may cause the device operating system to display the caller information received from the PNS 50 in an alert notification message informing the user that a call is incoming. The receipt of the push notification may also cause automatic display of interactive icons to receive user input, such as “Accept call” and “Decline call” icons. If an accept call icon is activated, the second telecommunication device 60 operating system may automatically open the client application stored in associated memory. In turn, the client application may automatically open a browser on the second telecommunication device 60 and establish an active Internet TCP/IP or UDP/IP session with the VoIP platform 30 over the Internet 40 in steps 108 and 110.

In step 112, once the active Internet session is established, the second telecommunication device 60, under the direction of the client application, may send a data signal communicating a message to the VoIP platform 30 requesting that the incoming call be redirected through the active Internet session. In response to receipt of the data signal request, in step 114 the VoIP platform 30 may automatically transmit a data signal providing SDP information, including without limitation Codecs, to the second telecommunication device 60. The client application on the second telecommunication device 60 may respond to receipt of the SDP information by returning a data signal providing an auto-answer to the VoIP platform 30 in step 116.

In step 118, the VoIP platform 30 may automatically connect the second telecommunication device 60 with the first telecommunication device 10 for a voice session of the telephone call. Thereafter, the VoIP platform 30 may transmit voice data signals to the second telecommunication device 60 from the VoIP platform using the active Internet session responsive to receipt of voice signals at the VoIP platform from the first telecommunication device 10 over the PSTN 20.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed:

1. A method of connecting a telephone call between first and second telecommunication devices using a VoIP platform, comprising:
associating a virtual telephone number with a second telecommunication device in a VoIP platform memory;
associating the second telecommunication device with a push notification service in the VoIP platform memory;
receiving, at the VoIP platform, a data signal initiated by a first telecommunication device, said data signal identifying the virtual telephone number to which a telephone call is directed;
automatically identifying the second telecommunication device associated with the virtual telephone number using the VoIP platform responsive to receipt of the data signal identifying the virtual telephone number;
automatically determining if the second telecommunication device has an active Internet session in progress, responsive to identification of the second telecommunication device, using the VoIP platform;
automatically transmitting a push notification data signal for the second telecommunication device from the VoIP platform to a server associated with the push notification service if the second telecommunication device does not have an active Internet session in progress;
receiving a request at the VoIP platform from the second telecommunication device to establish an active Internet session between the second telecommunication device and the VoIP platform;
receiving a data signal providing a redirection request from the second telecommunication device at the VoIP platform using an established active Internet session;
automatically transmitting a data signal providing SDP information from the VoIP platform to the second telecommunication device responsive to receipt of the redirection request;
receiving a data signal providing an auto-answer from the second telecommunication device at the VoIP platform, said data signal providing an auto-answer being transmitted responsive to receipt of the data signal providing SDP information at the second telecommunication device;
automatically connecting the second telecommunication device with the first telecommunication device at the VoIP platform for a voice session of the telephone call; and
transmitting a voice data signal to the second telecommunication device from the VoIP platform using the active Internet session responsive to receipt of a voice signal at the VoIP platform from the first telecommunication device.

2. The method of claim 1, further comprising: causing a ring state for the first telecommunication device between the time of automatically identifying the second telecommunication device and automatically connecting the second telecommunication device with the first telecommunication device for the voice session.

3. The method of claim 1, wherein the push notification includes a unique call identifier and identification information for the first telecommunication device.

4. The method of claim 1, wherein establishing an active Internet session between the second telecommunication device and the VoIP platform results from automatically opening a client application associated with VoIP platform on the second telecommunication device responsive to receipt of a push notification data signal transmitted from the server to the second telecommunication device.

5. The method of claim 4, wherein establishing an active Internet session further requires a haptic input to the second telecommunication device.

6. The method of claim 4, wherein the second telecommunication device is programmed with a plurality of client applications each associated with one of a plurality of corresponding VoIP platforms.

7. The method of claim 1, wherein the operator of the VoIP platform and the operator of the push notification service are unaffiliated.

8. A computer-implemented system for automatically connecting a telephone call between first and second telecommunication devices, comprising:
means for receiving a data signal initiated by a first telecommunication device, said data signal identifying a virtual telephone number to which a telephone call is directed;
means for automatically identifying a second telecommunication device associated with the virtual telephone number;
means for automatically determining if the second telecommunication device has an active Internet session in progress;
means for identifying a push notification service with which the second telecommunication device is registered;
means for automatically transmitting a push notification data signal to a server associated with the push notification service;
means for maintaining an active Internet session with the second telecommunication device;
means for automatically transmitting a data signal providing SDP information to the second telecommunication device; and
means for transmitting a voice data signal to the second telecommunication device responsive to receipt of a voice signal from the first telecommunication device.

9. A computer-readable medium including contents that are configured to cause a computing system to connect a telephone call between first and second telecommunication devices using a VoIP platform by performing a method comprising:
associating a virtual telephone number with a second telecommunication device in a VoIP platform memory;
associating the second telecommunication device with a push notification service in the VoIP platform memory;
receiving, at the VoIP platform, a data signal initiated by a first telecommunication device, said data signal identifying the virtual telephone number to which a telephone call is directed;
automatically identifying the second telecommunication device associated with the virtual telephone number using the VoIP platform responsive to receipt of the data signal identifying the virtual telephone number;
automatically determining if the second telecommunication device has an active Internet session in progress, responsive to identification of the second telecommunication device, using the VoIP platform;
automatically transmitting a push notification data signal for the second telecommunication device from the VoIP platform to a server associated with the push notification service if the second telecommunication device does not have an active Internet session in progress;
receiving a request at the VoIP platform from the second telecommunication device to establish an active Internet session between the second telecommunication device and the VoIP platform;
receiving a data signal providing a redirection request from the second telecommunication device at the VoIP platform using an established active Internet session;
automatically transmitting a data signal providing SDP information from the VoIP platform to the second telecommunication device responsive to receipt of the redirection request;
receiving a data signal providing an auto-answer from the second telecommunication device at the VoIP platform, said data signal providing an auto-answer being transmitted responsive to receipt of the data signal providing SDP information at the second telecommunication device;
automatically connecting the second telecommunication device with the first telecommunication device at the VoIP platform for a voice session of the telephone call; and
transmitting a voice data signal to the second telecommunication device from the VoIP platform using the active Internet session responsive to receipt of a voice signal at the VoIP platform from the first telecommunication device.

10. The computer-readable medium of claim 9, including contents that are configured to cause a computing system to connect a telephone call between first and second telecommunication devices using a VoIP platform by performing a method further comprising: causing a ring state for the first telecommunication device between the time of automatically identifying the second telecommunication device and automatically connecting the second telecommunication device with the first telecommunication device for the voice session.

11. The computer-readable medium of claim 9, wherein the push notification includes a unique call identifier and identification information for the first telecommunication device.

12. The computer-readable medium of claim 9, wherein establishing an active Internet session between the second telecommunication device and the VoIP platform results from automatically opening a client application associated with VoIP platform on the second telecommunication device responsive to receipt of a push notification data signal transmitted from the server to the second telecommunication device.

13. The computer-readable medium of claim 12, wherein establishing an active Internet session further requires a haptic input to the second telecommunication device.

14. The computer-readable medium of claim 12, wherein the second telecommunication device is programmed with a plurality of client applications each associated with one of a plurality of corresponding VoIP platforms.

15. The computer-readable medium of claim 9, wherein the operator of the VoIP platform and the operator of the push notification service are unaffiliated.
